(19) United States
(12) Patent Application Publication
(10) Pub. No.: US 2007/0126364 A1
(43) Pub. Date: Jun. 7, 2007

(54) Plasma display device and driver and driving method thereof

(76) Inventor: Joon-Yeon Kim, Suwon-si (KR)

Correspondence Address: Robert E. Bushnell, Suite 300, 1522 K Street, N.W., Washington, DC, 20005, US

(21) Appl. No.: 11/593,064

(22) Filed: Nov. 6, 2006

(30) Foreign Application Priority Data
Nov. 24, 2005 (KR) 10-2005-0112863

(51) Int. Cl. G09G 3/10

(52) U.S. Cl. 315/169.4; 315/169.2

(57) ABSTRACT

In a plasma display device, first and second transistors are coupled between a first power source for supplying a first voltage and a second power source for supplying a second voltage lower than the first voltage. First and second capacitors are coupled between the first power source and a second terminal of the first transistor, and a voltage corresponding to a difference between the first voltage and the second voltage is divided and charged by the first and second capacitors. Third and fourth capacitors are coupled between the second power source and a first terminal of the second transistor, and a voltage corresponding to a difference between the first voltage and the second voltage is divided and charged by the third and fourth capacitors.

### CLAIM OF PRIORITY

This application makes reference to, incorporates the same herein, and claims all benefits accruing under 35 U.S.C. § 119 from an application for PLASMA DISPLAY DEVICE, AND DRIVING DEVICE AND METHOD THEREOF earlier filed in the Korean Intellectual Property Office on the 24^{th} of Nov. 2005 and there duly assigned Ser. No. 10-2005-0112863.

### BACKGROUND OF THE INVENTION

1. Field of the Invention

The present invention relates to a plasma display device, and driver and driving method thereof.

2. Description of the Related Art

A plasma display device is a flat panel display that uses a plasma generated by a gas discharge process to display characters or images. It includes, depending on its size, more than several scores to millions of pixels arranged in a matrix pattern.

On a panel of the plasma display device, a field (e.g., 1 TV field) is divided into a plurality of subfields respectively having a weight. Gray scales are expressed by a combination of weights of subfields at which a display operation is generated from among the subfields. Each subfield has an address period in which an address operation for selecting discharge cells to emit light and discharge cells to emit no light from among a plurality of discharge cells is performed, and a sustain period in which a sustain discharge occurs in the selected discharge cells to perform a display operation during a period corresponding to a weight of a subfield.

Particularly, since a high level voltage and a low level voltage are alternately supplied to an electrode for performing the sustain discharge during the sustain period, a transistor for supplying the high and low voltages is required to have an internal voltage corresponding to a difference between the high and low voltages. Accordingly, because of the transistor having the high internal voltage, a cost of a sustain discharge driving circuit is increased.

### SUMMARY OF THE INVENTION

The present invention has been made in an effort to provide a plasma display device using a transistor having a low voltage in a sustain discharge driving circuit, a driving device thereof, and a driving method thereof.

One exemplary plasma display device according to an embodiment of the present invention includes: a plurality of first electrodes; a first node coupled to a first power source to supply a first voltage; and a second node coupled to a second power source to supply a second voltage; a third voltage lower than the second voltage is supplied to the plurality of first electrodes while the first voltage is supplied to the first node and the second node is supplied with the third voltage; and a fourth voltage higher than the first voltage is supplied to the plurality of first electrodes while the second voltage is supplied to the second node and the first node is supplied with the fourth voltage.

The plasma display device preferably further includes: a first transistor having a first terminal coupled to the first power source; a second transistor having a first terminal coupled to the first terminal of the first transistor, and a second terminal coupled to the second power source; a first capacitor having a first terminal coupled to the first node; a second capacitor having a first terminal coupled to a second terminal of the first capacitor, and a second terminal coupled to the first terminal of the second transistor; a third capacitor having a first terminal coupled to the second terminal of the first transistor; a fourth capacitor having a first terminal coupled to a second terminal of the third capacitor, and a second terminal coupled to the second node; a third transistor coupled to the first node and the plurality of first electrodes; a fourth transistor coupled to the second node and the plurality of first electrodes; a fifth transistor and a sixth transistor coupled between the plurality of first electrodes and a third node between the first capacitor and the second capacitor; and a seventh transistor and an eighth transistor coupled between the plurality of first electrodes and a fourth node between the third capacitor and the fourth capacitor.

The plasma display device preferably further includes: a first voltage increasing path including the second power source, the third capacitor, and the seventh transistor, and adapted to increase a voltage at the plurality of first electrodes; a second voltage increasing path including the second power source, the second capacitor, and the fifth transistor, and adapted to increase the voltage at the plurality of first electrodes; a third voltage increasing path including the first power source, the second capacitor, and the fifth transistor, and adapted to increase the voltage at the plurality of first electrodes; a first voltage decreasing path including the sixth transistor, the second capacitor, and the first power source, and adapted to decrease the voltage at the plurality of first electrodes; a second voltage decreasing path including the eighth transistor, the fourth capacitor, and the second power source, and adapted to decrease the voltage at the plurality of first electrodes; a third voltage decreasing path including the eighth transistor, the third capacitor, and the second power source, and adapted to decrease the voltage at the plurality of first electrodes; a first charging path including the first power source, the first and second capacitors, and the second transistor; and a second charging path including the first power source, the first transistor, and the third and fourth capacitors.

The first charging path preferably includes a first diode having an anode coupled to the first power source and a cathode coupled to the first node.

The second charging path preferably includes a second diode having a cathode coupled to the second power source and an anode coupled to the second node.

The plasma display device preferably further includes a first inductor coupled between the plurality of first electrodes and a node between the fifth and sixth transistors; the second and third voltage increasing paths preferably further include a third diode coupled between the fifth transistor and the first inductor, and the first voltage decreasing path preferably further includes a fourth diode coupled between the sixth transistor and the first inductor.

The plasma display device preferably further includes a second inductor coupled between the plurality of first electrodes and a node between the seventh and eighth transistors; the first voltage increasing path preferably further includes a fifth diode coupled between the seventh transistor and the second inductor, and the second and third voltage decreasing paths preferably further include a sixth diode coupled between the eighth transistor and the second inductor.

The second and third voltage increasing paths preferably further include the first inductor and the third diode coupled in series between the fifth transistor and the plurality of first electrodes, and the first voltage decreasing path preferably further includes the second inductor and the fourth diode coupled in series between the sixth transistor and the plurality of first electrodes.

The first voltage increasing path preferably further includes a third inductor and the fifth diode coupled in series between the seventh transistor and the plurality of first electrodes, and the second and third voltage decreasing paths preferably further include a fourth inductor and the sixth diode coupled in series between the eighth transistor and the plurality of first electrodes.

The plasma display device preferably further includes an inductor having a first terminal coupled between a node between the fifth and sixth transistors and a node between the seventh and eighth transistors, and a second terminal coupled to the plurality of first electrodes.

The first capacitor and the second capacitor are preferably of equal capacitance, and the third capacitor and the fourth capacitor are preferably of equal capacitance.

A fourth transistor is preferably turned on while the third voltage is supplied to the second node, and the third voltage is supplied to the plurality of first electrodes; a voltage at the plurality of first electrodes is preferably increased through a first voltage increasing path while a fifth voltage lower than the second voltage is supplied to a fourth node; the voltage at the plurality of first electrodes is preferably further increased through a second voltage increasing path while a sixth voltage higher than the second voltage is supplied to a third node; a voltage at the plurality of first electrodes is preferably further increased through a third voltage increasing path while a seventh voltage lower than the first voltage is supplied to the third node; and a third transistor is preferably turned on while the fourth voltage is supplied to the first node, and the fourth voltage is supplied to the plurality of first electrodes.

A third transistor is preferably turned on while the fourth voltage is supplied to the first node, and the fourth voltage is supplied to the plurality of first electrodes; a voltage of the plurality of first electrodes is preferably decreased through a first voltage decreasing path while a fifth voltage higher than the first voltage is supplied to a third node; the voltage at the plurality of first electrodes is preferably further decreased through a second voltage decreasing path while a sixth voltage higher than the second voltage is supplied to a fourth node; the voltage at the plurality of first electrodes is preferably further decreased through a third voltage decreasing path while a seventh voltage lower than the first voltage is supplied to the fourth node; and a fourth transistor is preferably turned on while the third voltage is supplied to the second node, and the third voltage is supplied to the plurality of first electrodes.

The first voltage is preferably a positive voltage, and the second voltage is preferably a negative voltage. The first and second voltages are preferably alternatively both positive voltages.

Another exemplary method of driving a plasma display device including a plurality of first electrodes and a plurality of second electrodes includes: supplying a third voltage to the plurality of first electrodes through a first power source for supplying a first voltage and first and second capacitors charged to a second voltage; increasing a voltage at the plurality of first electrodes through a first resonance path including the first power source and a first inductor; further increasing the voltage at the plurality of first electrodes through a second resonance path including the first power source and a second inductor; further increasing the voltage at the plurality of first electrodes through a third resonance path including the second inductor and a second power source supplying a fourth voltage higher than the first voltage; supplying a sixth voltage to the plurality of first electrodes through the second power source and third and fourth capacitors charged to a fifth voltage; decreasing the voltage at the plurality of first electrodes through a fourth resonance path including the second power source and the second inductor; further decreasing the voltage at the plurality of first electrodes through a fifth resonance path including the first power source and the first inductor; and further decreasing the voltage at the plurality of first electrodes through a sixth resonance path including the first power source and the first inductor.

The first resonance path preferably further includes a first transistor coupled between the first power source and the first inductor; the second resonance path preferably further includes a second transistor coupled between the first power source and the second inductor; the third resonance path preferably further includes a third transistor coupled between the second power source and the second inductor; the fourth resonance path preferably further includes a fourth transistor coupled between the second power source and the second inductor; the fifth resonance path preferably further includes a fifth transistor coupled between the first power source and the first inductor; and the sixth resonance path preferably further includes a sixth transistor coupled between the first power source and the first inductor.

Either increasing or decreasing the voltage of the plurality of first electrodes through the first, second, or sixth resonance path preferably further includes charging the third and fourth capacitors with the fifth voltage through a charging path including the second power source, the third and fourth capacitors, and the first power source.

Either increasing or decreasing the voltage of the plurality of first electrodes through the third to fifth resonance paths preferably further includes charging the first and second capacitors with the second voltage through a charging path including the second power source, the first and second capacitors, and the first power source.

The first and second inductors preferably have equal inductances. The second and third transistors are preferably the same. The fifth and sixth transistors are preferably the same.

Another exemplary plasma display device according to an embodiment of the present invention preferably includes: a plurality of first electrodes and a plurality of second electrodes; a first transistor having a first terminal coupled to a first power source to supply a first voltage; a second transistor having a first terminal coupled to a second terminal of the first transistor, and a second terminal coupled to a second power source to supply a second voltage lower than the first voltage; a first capacitor charged to a third voltage, and having a first terminal coupled to the first power source; a second capacitor charged to a fourth voltage, and having a first terminal coupled to a second terminal of the first capacitor and a second terminal coupled to a node between the first and second transistors; a third capacitor charged to a fifth voltage, and having a first terminal coupled to a node between the first and second transistors; a fourth capacitor charged to a sixth voltage, and having a first terminal coupled to a second terminal of the third capacitor and a second terminal coupled to the second power source; a third transistor coupled between the first terminal of the first capacitor and the plurality of first electrodes; a fourth transistor coupled between the second terminal of the fourth capacitor and the plurality of first electrodes; a fifth transistor coupled between the first terminal of the second capacitor and the plurality of first electrodes, the fifth transistor increasing a voltage at the plurality of first electrodes upon being turned on; a sixth transistor coupled between the first terminal of the second capacitor and the plurality of first electrodes, the sixth transistor decreasing the voltage at the plurality of first electrodes upon being turned on; a seventh transistor coupled between the second terminal of the third capacitor and the plurality of first electrodes, the seventh transistor increasing the voltage at the plurality of first electrodes upon being turned on; and an eighth transistor coupled between the second terminal of the third capacitor and the plurality of first electrodes, the eighth transistor decreasing the voltage at the plurality of first electrodes upon being turned on.

The plasma display device preferably further includes: an inductor having a first terminal coupled to a node between a first terminal of the fifth transistor and a first terminal of the sixth transistor; a first diode coupled between the first terminal of the fifth transistor and the first terminal of the inductor; and a second diode coupled between a first terminal of the sixth transistor and the first terminal of the inductor.

The first inductor and the first diode are preferably coupled in series between the first terminal of the fifth transistor and the plurality of first electrodes; and the second inductor and the second diode are preferably coupled in series between the first terminal of the sixth transistor and the plurality of first electrodes.

The plasma display device preferably further includes: an inductor having a first terminal coupled to a node between a first terminal of the seventh transistor and a first terminal of the eighth transistor; a first diode coupled between the first terminal of the seventh transistor and the first terminal of the inductor; and a second diode coupled between the first terminal of the eighth transistor and the first terminal of the inductor.

The first inductor and the first diode are preferably coupled in series between a first terminal of the seventh transistor and the plurality of first electrodes; and the second inductor and the second diode are preferably coupled in series between a first terminal of the eighth transistor and the plurality of first electrodes.

A voltage corresponding to a difference between the second voltage and a voltage of the third and fourth capacitors is preferably supplied to the first electrode upon the second and fourth transistors being turned on; the voltage at the plurality of first electrodes is preferably increased upon the fourth transistor being turned off and the seventh transistor being turned on; the voltage at the plurality of first electrodes is preferably further increased upon the seventh transistor being turned off and the fifth transistor being turned; the voltage at the plurality of first electrodes is preferably further increased upon the first transistor being turned on; and a voltage corresponding to a sum of the first voltage and a voltage of the first and second capacitors is preferably supplied to the plurality of first electrodes upon the fifth transistor being turned off and the third transistor being turned on.

A voltage corresponding to a sum of the first voltage and a voltage of the first and second capacitors is preferably supplied to the plurality of first electrodes upon the first and third transistors being turned on; the voltage at the plurality of first electrodes is preferably decreased upon the third transistor being turned off and the sixth transistor being turned on; the voltage at the plurality of first electrodes is preferably further decreased upon the first and sixth transistors being turned off and the eighth transistor being turned on; the voltage at the plurality of first electrodes is preferably further decreased upon the second transistor being turned on; and a voltage corresponding to a difference between the second voltage and a voltage of the third and fourth capacitors is preferably supplied to the plurality of first electrodes upon the fourth transistor being turned.

The first and fourth voltages are preferably equal, and the fifth and sixth voltages are preferably equal.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a diagram of a plasma display device according to an exemplary embodiment of the present invention.

FIG. 2 to FIG. 4 are respective driving waveforms of a plasma display device according to first to third exemplary embodiments of the present invention.

FIG. 5 is a diagram of a sustain discharge driving circuit of a scan electrode driver, the sustain discharge driving circuit generating the driving waveforms of FIG. 4.

FIG. 6 is a signal timing diagram of the sustain discharge driving circuit for generating the driving waveform of FIG. 4.

FIG. 7A to FIG. 7H are respective diagrams of the operation of the sustain discharge driving circuit of FIG. 5 according to the signal timing diagram of FIG. 6.

### DETAILED DESCRIPTION OF THE INVENTION

In the following detailed description, only certain exemplary embodiments of the present invention have been shown and described, simply by way of illustration. As those skilled in the art would realize, the described embodiments can be modified in various different ways, all without departing from the spirit or scope of the present invention. Accordingly, the drawings and description are to be regarded as illustrative in nature and not restrictive. Like reference numerals designate like elements throughout the specification.

A plasma display device according to an exemplary embodiment of the present invention and a driving device and method thereof are described below with reference to the drawing figures.

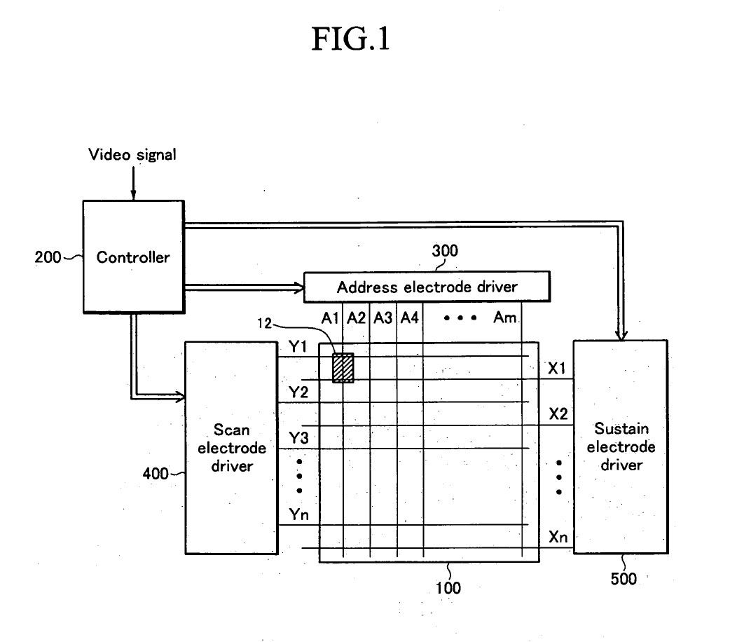

FIG. 1 is a diagram of a plasma display device according to an exemplary embodiment of the present invention.

As shown in FIG. 1, the plasma display device according to the exemplary embodiment of the present invention includes a Plasma Display Panel (PDP) 100, a controller 200, an address electrode driver 300, a scan electrode driver 400, and a sustain electrode driver 500.

The PDP 100 includes a plurality of address electrodes A1 to Am (hereinafter, referred to as “A electrodes”) extending in a column direction, and a plurality of sustain and scan electrodes X1 to Xn and Y1 to Yn (hereinafter, referred to as “X electrodes” and “Y electrodes”) extending in a row direction by pairs. The X electrodes X1 to Xn are formed in correspondence with the Y electrodes Y1 to Yn, and a display operation is performed by the X and Y electrodes in a sustain period. The Y and X electrodes Y1 to Yn and X1 to Xn are arranged perpendicular to the A electrodes A1 to Am. A discharge space formed at an area where the address electrodes A1 to Am cross the sustain and scan electrodes X1 to Xn and Y1 to Yn forms a discharge cell 12. The configuration of the PDP 100 of FIG. 1 is merely an example, and other exemplary configurations can be applied to the present invention.

The controller 200 outputs X, Y, and A electrode driving control signals after receiving an external image signal. In addition, the controller 200 operates on each frame divided into a plurality of subfields having respective weight values, and each subfield includes a reset period, an address period, and a sustain period.

After receiving the A electrode driving control signal from the controller 200, the address electrode driver 300 supplies display data signals for selecting discharge cells to be displayed to the respective address electrodes A1-Am.

The scan electrode driver 400 supplies a driving voltage to the Y electrodes Y1 to Yn after receiving the Y electrode driving control signal from the controller 200, and the sustain electrode driver 500 supplies a driving voltage to the X electrodes X1 to Xn after receiving the X electrode driving control signal from the controller 200.

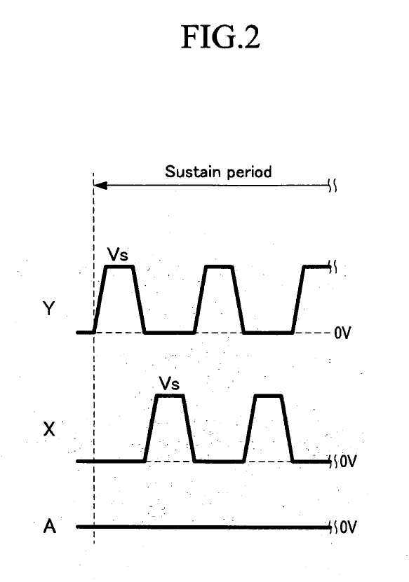

Driving waveforms of the plasma display device according to the exemplary embodiment of the present invention are described below with reference to FIG. 2 to FIG. 4. For convenience of descriptions, a driving waveform supplied to the Y, X, and A electrodes forming one cell has been described.

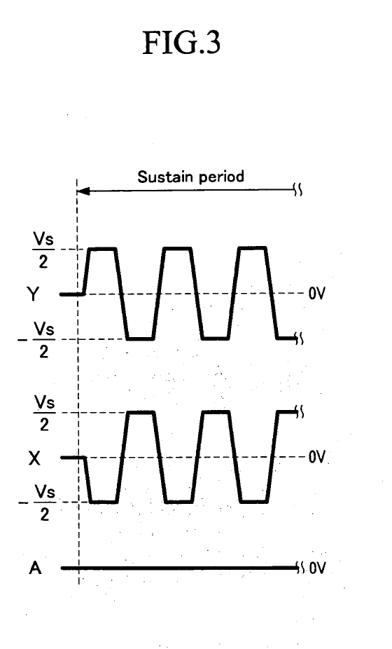

FIG. 2 and FIG. 3 are respective driving waveforms of the plasma display device according to first and second exemplary embodiments of the present invention. In FIG. 2 and FIG. 3, driving waveforms of the sustain period are illustrated.

As shown in FIG. 2, a sustain pulse has a high level voltage (Vs voltage) and a low level voltage (0V voltage), and sustain pulses of opposite phases are alternately supplied to the Y and X electrodes during the sustain period. The sustain pulse is repeatedly supplied to the Y and X electrodes a number of times corresponding to a weight value displayed by the corresponding subfield. That is, the 0V voltage is supplied to the X electrode when the Vs voltage is supplied to the Y electrode, and the 0V voltage is supplied to the Y electrode when the Vs voltage is supplied to the X electrode. Accordingly, a voltage difference between the Y and X electrodes alternately becomes Vs and −Vs voltages, and therefore, a sustain discharge is generated in a turn-on discharge cell a predetermined number of times.

In addition, differing from FIG. 2, sustain pulses having a high level voltage (Vs/2 voltage) and a low level voltage (−Vs/2 voltage) in opposite phases can be supplied to the Y and X electrodes as shown in FIG. 3. In this case, the −Vs/2 voltage is supplied to the X electrode when the Vs/2 voltage is supplied to the Y electrode, and the −Vs/2 voltage is supplied to the Y electrode when the Vs/2 voltage is supplied to the X electrode. In addition, the voltage difference between the Y and X electrodes is alternately the Vs and −Vs voltages in a like manner of the sustain pulses of FIG. 2.

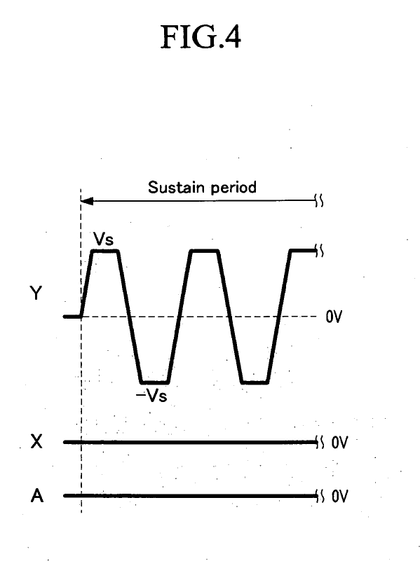

While the sustain pulse alternately has a high level voltage and a low level voltage, and the sustain pulses of opposite phases are respectively supplied to the X electrode and the Y electrode in the first exemplary embodiment of the present invention, the sustain pulse can also be supplied to one of the X and Y electrodes, as described below with reference to FIG. 4.

FIG. 4 are driving waveforms of the plasma display device according to a third exemplary embodiment of the present invention.

As shown in FIG. 4, a sustain pulse alternately having the Vs voltage and the −Vs voltage is supplied to the Y electrode while the 0V voltage is supplied to the X electrode during the sustain period. Accordingly, the voltage difference between the Y and X electrodes is alternately the voltage differences of Vs and −Vs in a like manner of the sustain pulse of FIG. 2.

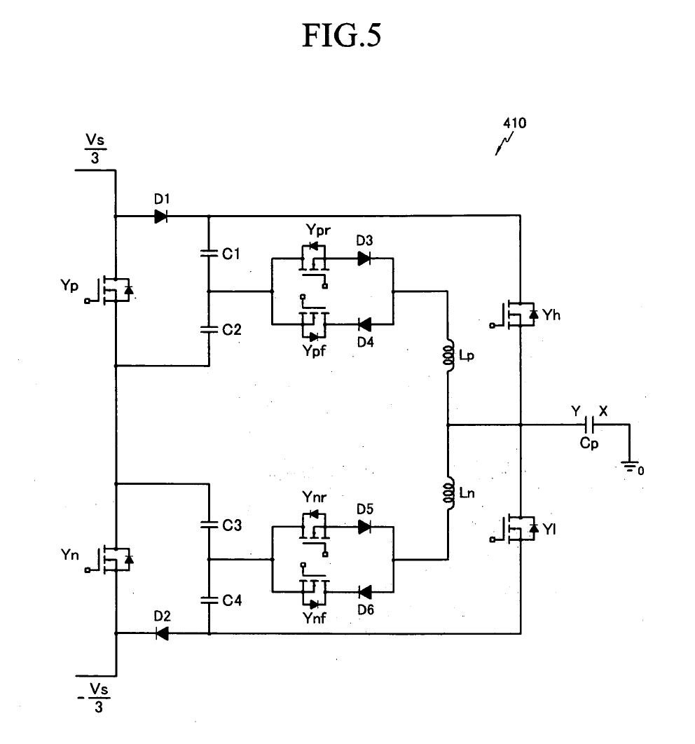

A driving circuit for generating the driving waveforms of FIG. 4 is described below with reference to FIG. 5.

FIG. 5 is a diagram of a sustain discharge driving circuit 410 of the scan electrode driver 400. The sustain discharge driving circuit 410 generates the driving waveforms shown in FIG. 4. For better understanding and ease of description, the sustain discharge driving circuit 410 is coupled to the plurality of Y electrodes Y1 to Yn, as illustrated in FIG. 5, and the sustain discharge driving circuit 410 can be included in the scan electrode driver 400 of FIG. 1. Since the 0V voltage is supplied to the X electrodes X1 to Xn during the sustain period, the plurality of X electrodes X1 to Xn are coupled to a ground terminal 0 for supplying a ground voltage 0V. In addition, for the driving waveforms of FIG. 2 and FIG. 3, a sustain discharge driving circuit having the same configuration as the sustain discharge driving circuit 410 of FIG. 5 can be coupled to the plurality of X electrodes. For better understanding and ease of description, in the sustain discharge driving circuit 410, one X electrode and one Y electrode are illustrated, and a capacitance formed by the X and Y electrodes is illustrated as a panel capacitor Cp.

As shown in FIG. 5, the sustain discharge driving circuit 410 includes transistors Yp, Yn, Ypr, Ypf, Ynr, Ynf, Yh, and Yl, capacitors C1, C2, C3, and C4, inductors Lp and Ln, and diodes D1, D2, D3, D4, D5, and D6.

In FIG. 5, the transistors Yp, Yn, Ypr, Ypf, Ynr, Ynf, Yh, and Yl are illustrated as n-channel field effect transistors, particularly n-channel metal oxide semiconductor (NMOS) transistors, and a body diode is formed in a direction from a source to a drain in the respective transistors Yp, Yn, Ypr, Ypf, Ynr, Ynf, Yh, and Yl.

Rather than using NMOS transistors, other transistors having similar functions can be used as transistors Yp, Yn, Ypr, Ypf, Ynr, Ynf, Yh, and Yl. While the transistors Yp, Yn, Ypr, Ypf, Ynr, Ynf, Yh, and Yl are respectively illustrated as single transistors in FIG. 5, each of the transistors Yp, Yn, Ypr, Ypf, Ynr, Ynf, Yh, and Yl can be formed of a plurality of transistors coupled in parallel.

A drain of the transistor Yp is coupled to a power source Vs/3 for supplying a Vs/3 voltage corresponding to one third of the high level voltage Vs of the sustain pulse, and a source of the transistor Yp is coupled to a drain of the transistor Yn. A source of the transistor Yn is coupled to a power source −Vs/3 for supplying a −Vs/3 voltage corresponding to one third of the low level voltage −Vs of the sustain pulse.

A first terminal of the capacitor C1 is coupled to the power source Vs/3, and a second terminal of the capacitor C1 is coupled to a first terminal of the capacitor C2. A second terminal of the capacitor C2 is coupled to the source of the transistor Yp. A first terminal of the capacitor C3 is coupled to a node between the source of the transistor Yp and the drain of the transistor Yn, and a second terminal of the capacitor C3 is coupled to a first terminal of the capacitor C4. A second terminal of the capacitor C4 is coupled to the power source −Vs/3. An anode of the diode D1 is coupled to the power source Vs/3, and a cathode thereof is coupled to the first terminal of the capacitor C1. A cathode of the diode D2 is coupled to the power source −Vs/3, and an anode thereof is coupled to the second terminal of the capacitor C4.

The diodes D1 and D2 form a charging path for respectively charging the capacitors C1, C2, C3, and C4 with the Vs/3 voltage when the respective transistors Yn and Yp are turned on. Other elements (e.g., transistors) for forming the charging path can be used rather than using the diodes D1 and D2. In FIG. 5, it is assumed that the respective capacitors C1, C2, C3, and C4 are charged to the Vs/3 voltage through the above charging path.

A drain of the transistor Yh is coupled to the first terminal of the capacitor C1, a source of the transistor Yl is coupled to the second terminal of the capacitor C4, and a source of the transistor Yh and a drain of the transistor Yl are coupled to the Y electrode of the panel capacitor Cp.

A drain of the transistor Ypr and a source of the transistor Ypf are coupled to a node between the second terminal of capacitor C1 and the first terminal of the capacitor C2, and a drain of the transistor Ynr and a source of the transistor Ynf are coupled to a node between the second terminal of the capacitor C3 and a first terminal of the capacitor C4.

A node between a source of the transistor Ypr and a drain of the transistor Ypf is coupled to a first terminal of the inductor Lp, and a node between a source of the transistor Ynr and a drain of the transistor Ynf is coupled to a first terminal of the inductor Ln. A second terminal of the inductor Lp and a second terminal of the inductor Ln are coupled to the Y electrode of the panel capacitor Cp.

An anode of the diode D3 is coupled to the source of the transistor Ypr, and a cathode thereof is coupled to the first terminal of the inductor Lp. A cathode of the diode D4 is coupled to a drain of the transistor Ypf, and an anode thereof is coupled to the first terminal of the inductor Lp. An anode of the diode D5 is coupled to a source of the transistor Ynr, and a cathode thereof is coupled to the first terminal of the inductor Ln. A cathode of the diode D6 is coupled to the drain of the transistor Ynf, and an anode thereof is coupled to the first terminal of the inductor Ln.

The diodes D3 and D5 respectively interrupt current paths formed by respective body diodes of the transistors Ypr and Ynr, and set a voltage increasing path for increasing the voltage at the Y electrode. The diodes D4 and D6 respectively interrupt current paths formed by respective body diodes of the transistors Ypf and Ynf, and set a voltage decreasing path for decreasing the voltage at the Y electrode.

While the inductors Lp and Ln are respectively coupled to the voltage increasing and decreasing paths in FIG. 5, a single inductor can also be coupled to an overlapped part of the voltage increasing path and decreasing path, and an inductor can be respectively coupled between the respective transistors Ypr, Ypf, Ynr, and Ynf and the respective diodes D3, D4, D5, and D6.

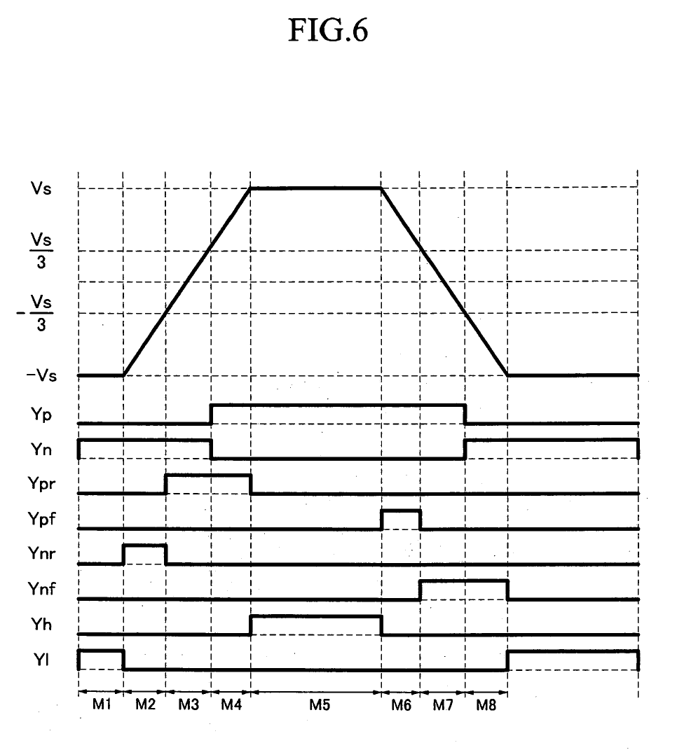

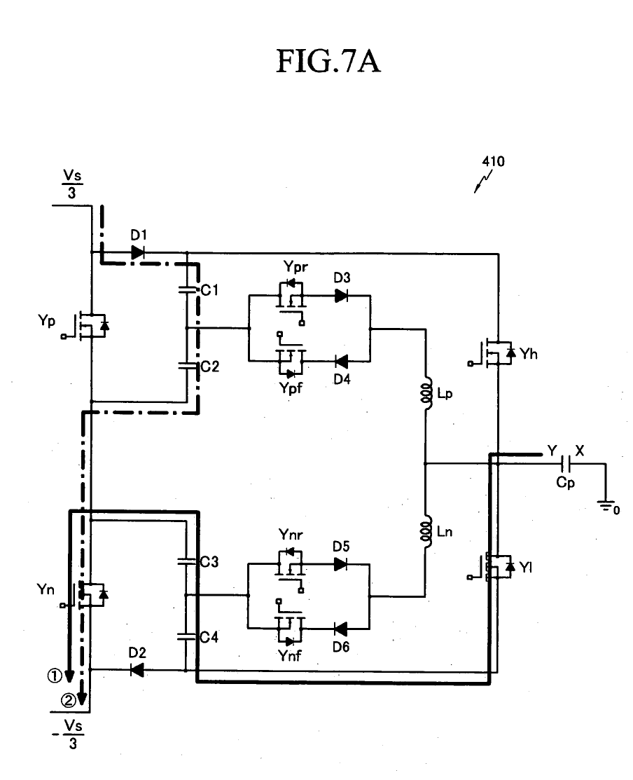

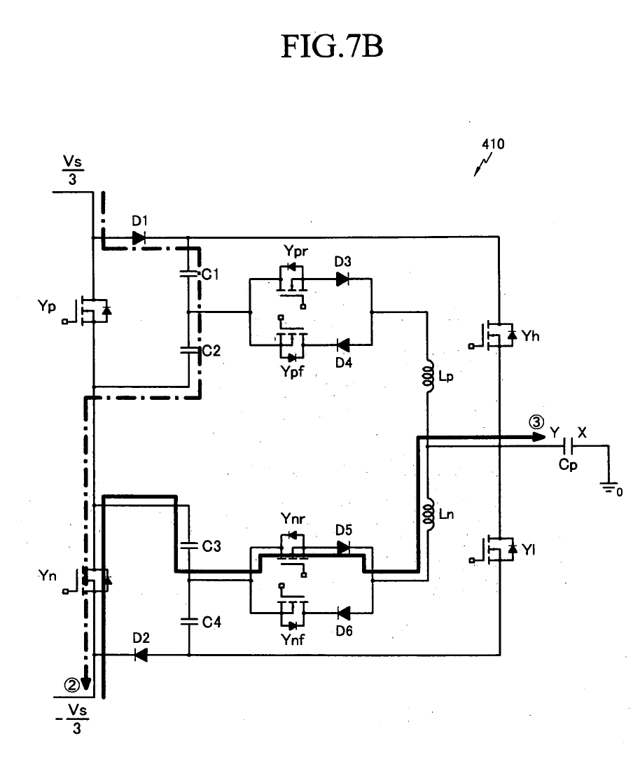

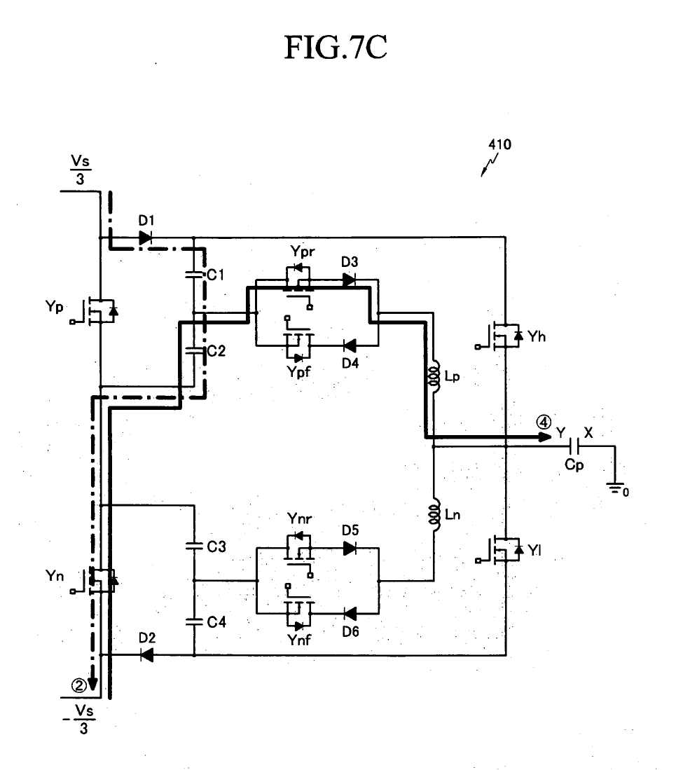

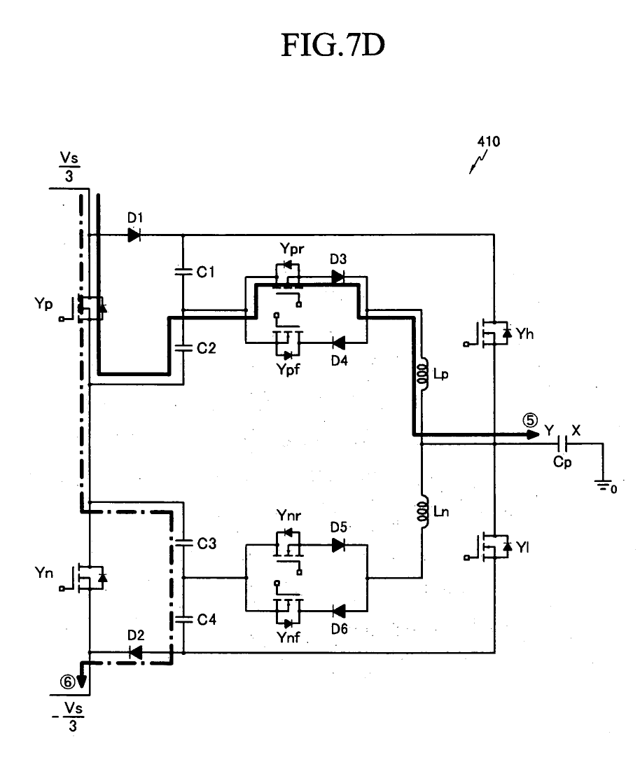

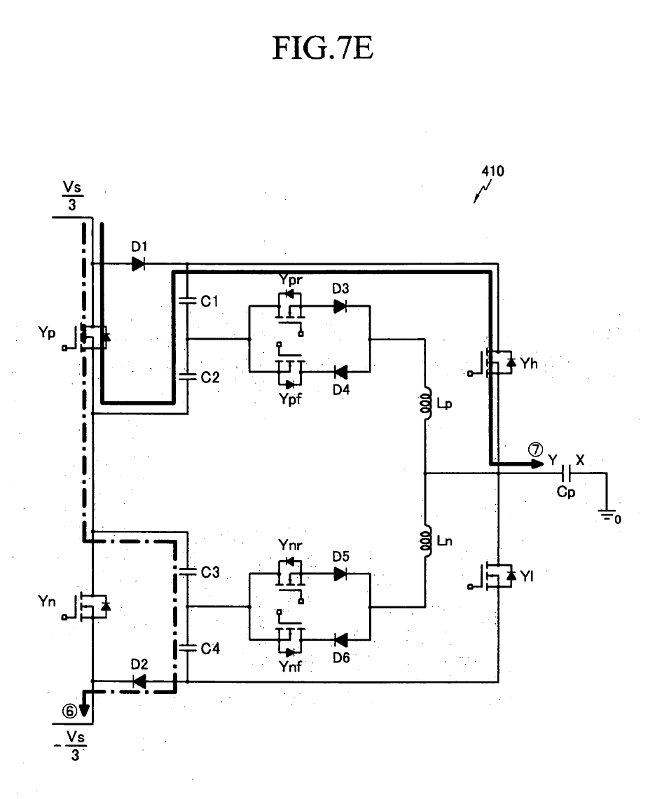

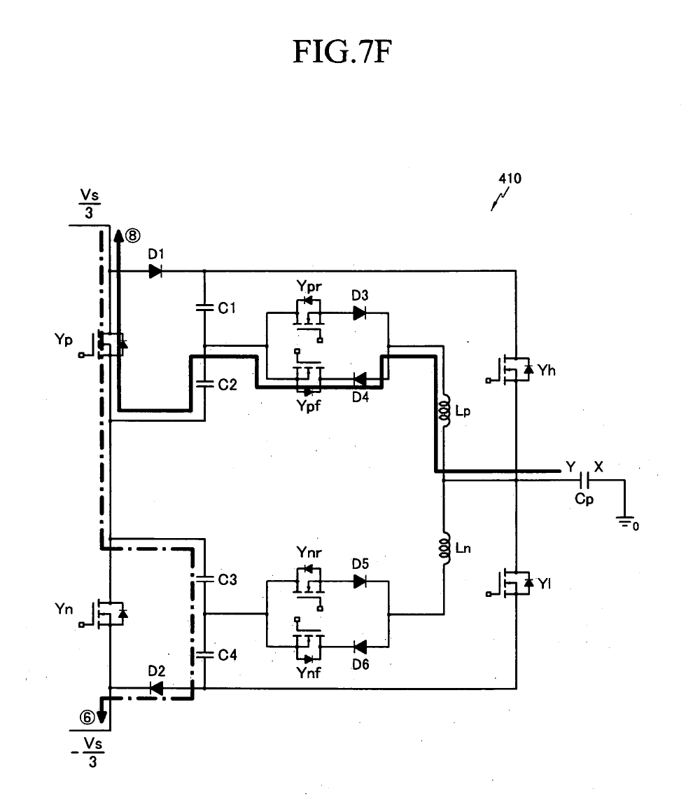

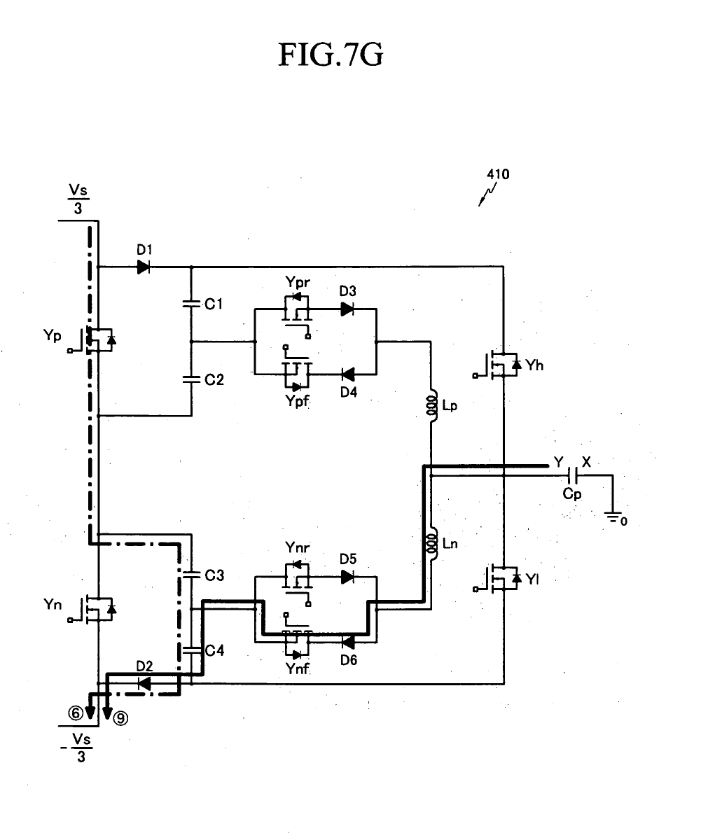

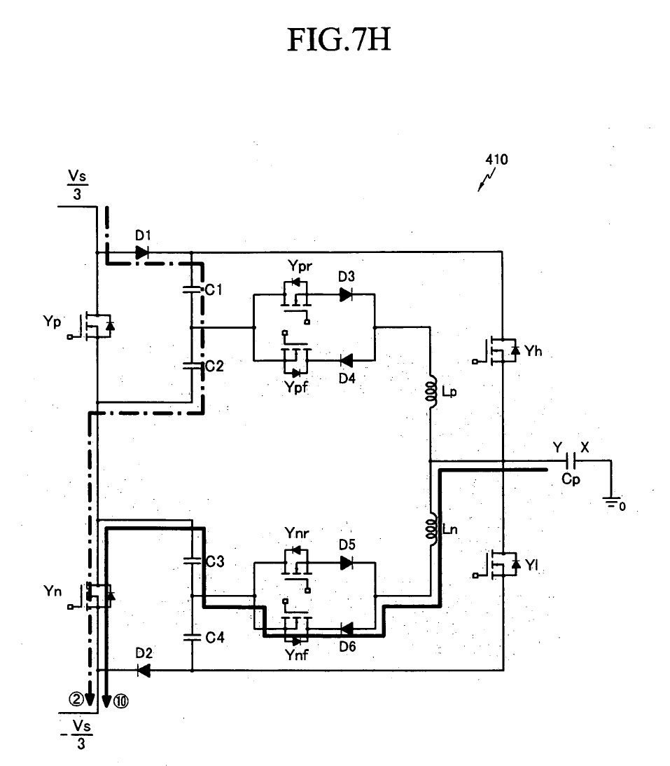

The operation of the sustain discharge driving circuit 410 of FIG.5 is described below with reference to FIG. 6, and FIG. 7A to FIG. 7H.

FIG. 6 is a signal timing diagram of the sustain discharge driving circuit 410 for generating the driving waveform of FIG. 4, and FIG. 7A to FIG. 7H are respective diagrams of the operation of the sustain discharge driving circuit 410 of FIG. 5 according to the signal timing of FIG. 6. It is assumed that the transistors Yn and Ynf have been turned on before a first mode M1 is started.

Referring to FIG. 6 and FIG. 7A, in the first mode M1, the transistor Ynf is turned off, the transistor Yl is turned on, and the −Vs voltage is supplied to the Y electrode of the panel capacitor Cp through a path \hat{1} of the transistor Yl, the capacitor C4, the capacitor C3, the transistor Yn, and the power source −Vs/3, as shown in FIG. 7A. That is, the −Vs voltage, which is lower than the −Vs/3 source voltage by a sum 2Vs/3 of the voltages charged at the capacitors C3 and C4, is supplied to the Y electrode.

In addition, since a path \hat{2} of the power source Vs/3, the diode D1, the capacitor C1, the capacitor C2, the transistor Yn, and the power source −Vs/3 is formed when the transistor Yn is turned on while the transistor Yp is turned off, the capacitor C1 and the capacitor C2 are respectively charged with the Vs/3 voltage since a difference between the voltages supplied to the power sources Vs/3 and −Vs/3 is 2Vs/3. In this case, since a source voltage of the transistor Yh becomes −Vs voltage in the path \hat{1} and a drain voltage of the transistor Yh becomes the Vs/3 voltage in the path \hat{2}, a voltage between the source and drain of the transistor Yh becomes a 4Vs/3 voltage. Accordingly, the transistor Yh can be used as a transistor having the 4Vs/3 voltage.

In addition, since a source voltage of the transistor Yp is −Vs/3 and a drain voltage of the transistor Yp is a Vs/3 voltage, the transistor Yp can be used as a transistor having the 2Vs/3 voltage.

Subsequently, since the transistor Yl is turned off and the transistor Ynr is turned on at a second mode M2, a resonance occurs in a path \hat{3} of the power source −Vs/3, the transistor Yn, the capacitor C3, the transistor Ynr, the diode D5, the inductor Ln, and the Y electrode of the panel capacitor Cp as shown in FIG. 7B. Accordingly, the voltage at the Y electrode of the panel capacitor Cp is increased from the −Vs voltage to the −Vs/3 voltage.

Subsequently, since the transistor Ynr is turned off and the transistor Ypr is turned on at a third mode M3, a resonance occurs in a path \hat{4} of the power source −Vs/3, the transistor Yn, the capacitor C2, the transistor Ypr, the diode D3, the inductor Lp, and the Y electrode of the panel capacitor Cp as shown in FIG. 7C. Accordingly, the voltage at the Y electrode of the panel capacitor Cp is increased from the −Vs/3 voltage to the Vs/3 voltage.

Subsequently, since the transistor Yn is turned off and the transistor Yp is turned on at a fourth mode M4, a resonance occurs in a path \hat{5} of the power source Vs/3, the transistor Yp, the capacitor C2, the transistor Ypr, the diode D3, the inductor Lp, and the Y electrode of the panel capacitor Cp as shown in FIG. 7D. Accordingly, the voltage at the Y electrode of the panel capacitor Cp is increased from the Vs/3 voltage to the Vs voltage.

In addition, as shown in FIG. 7D, since a path \hat{6} of the power source Vs/3, the transistor Yp, the capacitor C3, the capacitor C4, the diode D2, and the power source −Vs/3 is formed, the capacitors C3 and C4 are charged with the Vs/3 voltage divided from the 2Vs/3 voltage corresponding to a difference between the power sources Vs/3 and −Vs/3.

Subsequently, since the transistor Ypr is turned off and the transistor Yh is turned on at a fifth mode M5, the Vs voltage is supplied to the Y electrode through a path \hat{7} of the power source Vs/3, the transistor Yp, the capacitor C2, the capacitor C1, the transistor Yh, and the Y electrode of the panel capacitor Cp as shown in FIG. 7E. That is, the Vs voltage, that is higher than the source voltage Vs/3 by a sum 2Vs/3 of the voltages charged in the capacitor C1 and the capacitor C2, is supplied to the Y electrode.

Furthermore, since the −Vs/3 voltage is supplied to the source of the transistor Yl through the path \hat{6} and the Vs voltage is supplied to the drain of the transistor Yl through the path \hat{7}, the 4Vs/3 voltage is supplied between the source and the drain of the transistor Yl. Accordingly, the transistor Yl can be used as a transistor having the 4Vs/3 voltage.

In addition, since a drain voltage of the transistor Yn is the Vs/3 voltage and a source voltage of the transistor Yn is the −Vs/3 voltage, the transistor Yn can be used as a transistor having the 2Vs/3 voltage.

Since the transistor Yh is turned off and the transistor Ypf is turned on at a sixth mode M6, a resonance occurs in a path \hat{8} of the Y electrode of the panel capacitor Cp, the inductor Lp, the diode D4, the transistor Ypf, the capacitor C2, the transistor Yp, and the power source Vs/3 as shown in FIG. 7F. Accordingly, energy stored in the panel capacitor Cp is recovered to the power source Vs/3 through the inductor Lp, and the voltage at the Y electrode is decreased from the Vs voltage to the Vs/3 voltage.

Subsequently, since the transistors Ypf and Yp are turned off and the transistor Ynf is turned on at a seventh mode M7, a resonance occurs in a path \hat{9} of the Y electrode of the panel capacitor Cp, the inductor Ln, the diode D6, the transistor Ynf, the capacitor C4, and the power source −Vs/3 as shown in FIG. 7G. Accordingly, the voltage at the Y electrode of the panel capacitor Cp is decreased from the Vs/3 voltage to the −Vs/3 voltage.

Subsequently, since the transistor Yn is turned on at an eighth mode M8, a resonance occurs in a path \hat{10} of the Y electrode of the panel capacitor Cp, the inductor Ln, the diode D6, the transistor Ynf, the capacitor C3, the transistor Yn2, and the power source −Vs/3 as shown in FIG. 7H. Accordingly, the voltage at the Y electrode of the panel capacitor Cp is decreased from the −Vs/3 voltage to the −Vs voltage.

In addition, since the path \hat{2} is formed as shown in FIG. 7H, the capacitors C1 and C2 are respectively charged with the Vs/3 voltage divided from the 2Vs/3 voltage corresponding to a difference between the voltages supplied to the power sources Vs/3 and −Vs/3.

As described above, the Vs voltage and the −Vs voltage can be alternately supplied to the Y electrode since the first mode M1 to the eighth mode M8 are repeatedly performed during the sustain period by the number of times corresponding to a weight value of a corresponding subfield. In addition, the transistors Yh and Yl can be used as a transistor having a ⅔ voltage of the voltage supplied to the Y electrode (i.e., the 4Vs/3 voltage), and the transistors Yp and Yn can be used as a transistor having the 2Vs/3 voltage.

While the driving waveforms according to the third exemplary embodiment of the present invention have been described as being generated by the circuits of FIG. 7A to FIG. 7H, the driving waveforms according to the first and second exemplary embodiments of the present invention can also be generated by the circuit of FIG. 5.

In further detail, in the circuit shown in FIG. 5, the drain of the transistor Yp is coupled to a power source supplying the 2Vs/3 voltage, and the source of the transistor Yn is coupled to a power source supplying the Vs/3 voltage. The capacitors C1 and C2 are respectively charged to the Vs/6 voltage when the transistor Yp is turned off and the transistor Yn is turned on, and the capacitors C3 and C4 are respectively charged with the Vs/6 voltage when the transistor Yn is turned off and the transistor Yp is turned on. Accordingly, the sustain pulse alternately having the Vs voltage and the 0V voltage can be supplied to the Y electrode through the paths shown in FIG. 7A to FIG. 7H. A sustain discharge driving circuit (not shown) coupled to the X electrode has the same configuration as the sustain discharge driving circuit 410. The sustain discharge driving circuit coupled to the X electrode can supply the 0V voltage to the X electrode while the Vs voltage is supplied to the Y electrode, and can supply the Vs voltage to the X electrode while the Vs voltage is supplied to the Y electrode.

In addition, in the circuit of FIG. 5, the drain of the transistor Yp is coupled to a power source supplying a Vs/6 voltage, and a source of the transistor Yn is coupled to a power source supplying −Vs/6 voltage. The capacitors C1 and C2 are respectively charged to the Vs/6 voltage when the transistor Yp is turned off and the transistor Yn is turned on, and the capacitors C3 and C4 are respectively charged with the Vs/6 voltage when the transistor Yn is turned off and the transistor Yp is turned on. Accordingly, the sustain pulse alternately having the Vs/2 voltage and the −Vs/2 voltage can be supplied to the Y electrode through the paths shown in FIG. 7A to FIG. 7H. The sustain discharge driving circuit (not shown) coupled to the X electrode has the same configuration as the sustain discharge driving circuit 410. The sustain discharge driving circuit coupled to the X electrode can supply the sustain pulse alternately having the Vs/2 voltage and the −Vs/2 voltage to the X electrode in an opposite phase of the sustain pulse supplied to the Y electrode.

While the present invention has been described in connection with what is presently considered to be practical exemplary embodiments, it is to be understood that the present invention is not limited to the discussed embodiments, but, on the contrary, is intended to cover various modifications and equivalent arrangements included within the spirit and scope of the appended claims.

According to the exemplary embodiments of the present invention, a transistor having a low internal voltage can be used in a sustain discharge driving circuit, and reactive power consumption can be reduced.

What is claimed is:

1. A plasma display device, comprising:
a plurality of first electrodes;
a first node coupled to a first power source to supply a first voltage; and
a second node coupled to a second power source to supply a second voltage;
wherein a third voltage lower than the second voltage is supplied to the plurality of first electrodes while the first voltage is supplied to the first node and the second node is supplied with the third voltage; and
a fourth voltage higher than the first voltage is supplied to the plurality of first electrodes while the second voltage is supplied to the second node and the first node is supplied with the fourth voltage.

2. The plasma display device of claim 1, further comprising:
a first transistor having a first terminal coupled to the first power source;
a second transistor having a first terminal coupled to the first terminal of the first transistor, and a second terminal coupled to the second power source;
a first capacitor having a first terminal coupled to the first node;
a second capacitor having a first terminal coupled to a second terminal of the first capacitor, and a second terminal coupled to the first terminal of the second transistor;
a third capacitor having a first terminal coupled to the second terminal of the first transistor;
a fourth capacitor having a first terminal coupled to a second terminal of the third capacitor, and a second terminal coupled to the second node;
a third transistor coupled to the first node and the plurality of first electrodes;
a fourth transistor coupled to the second node and the plurality of first electrodes;
a fifth transistor and a sixth transistor coupled between the plurality of first electrodes and a third node between the first capacitor and the second capacitor; and
a seventh transistor and an eighth transistor coupled between the plurality of first electrodes and a fourth node between the third capacitor and the fourth capacitor.

3. The plasma display device of claim 2, further comprising:
a first voltage increasing path including the second power source, the third capacitor, and the seventh transistor, and adapted to increase a voltage at the plurality of first electrodes;
a second voltage increasing path including the second power source, the second capacitor, and the fifth transistor, and adapted to increase the voltage at the plurality of first electrodes;
a third voltage increasing path including the first power source, the second capacitor, and the fifth transistor, and adapted to increase the voltage at the plurality of first electrodes;
a first voltage decreasing path including the sixth transistor, the second capacitor, and the first power source, and adapted to decrease the voltage at the plurality of first electrodes;
a second voltage decreasing path including the eighth transistor, the fourth capacitor, and the second power source, and adapted to decrease the voltage at the plurality of first electrodes;
a third voltage decreasing path including the eighth transistor, the third capacitor, and the second power source, and adapted to decrease the voltage at the plurality of first electrodes;
a first charging path including the first power source, the first and second capacitors, and the second transistor; and
a second charging path including the first power source, the first transistor, and the third and fourth capacitors.

4. The plasma display device of claim 3, wherein the first charging path comprises a first diode having an anode coupled to the first power source and a cathode coupled to the first node.

5. The plasma display device of claim 4, wherein the second charging path comprises a second diode having a cathode coupled to the second power source and an anode coupled to the second node.

6. The plasma display device of claim 5, further comprising a first inductor coupled between the plurality of first electrodes and a node between the fifth and sixth transistors;
wherein the second and third voltage increasing paths further comprise a third diode coupled between the fifth transistor and the first inductor, and the first voltage decreasing path further comprises a fourth diode coupled between the sixth transistor and the first inductor.

7. The plasma display device of claim 6, further comprising a second inductor coupled between the plurality of first electrodes and a node between the seventh and eighth transistors;
wherein the first voltage increasing path further comprises a fifth diode coupled between the seventh transistor and the second inductor, and the second and third voltage decreasing paths further comprise a sixth diode coupled between the eighth transistor and the second inductor.

8. The plasma display device of claim 5, wherein the second and third voltage increasing paths further comprise the first inductor and the third diode coupled in series between the fifth transistor and the plurality of first electrodes, and the first voltage decreasing path further comprises the second inductor and the fourth diode coupled in series between the sixth transistor and the plurality of first electrodes.

9. The plasma display device of claim 8, wherein the first voltage increasing path further comprises a third inductor and the fifth diode coupled in series between the seventh transistor and the plurality of first electrodes, and the second and third voltage decreasing paths further comprise a fourth inductor and the sixth diode coupled in series between the eighth transistor and the plurality of first electrodes.

10. The plasma display device of claim 5, further comprising an inductor having a first terminal coupled between a node between the fifth and sixth transistors and a node between the seventh and eighth transistors, and a second terminal coupled to the plurality of first electrodes.

11. The plasma display device of claim 2, wherein the first capacitor and the second capacitor are of equal capacitance, and the third capacitor and the fourth capacitor are of equal capacitance.

12. The plasma display device of claim 5, wherein a fourth transistor is turned on while the third voltage is supplied to the second node, and the third voltage is supplied to the plurality of first electrodes;
a voltage at the plurality of first electrodes is increased through a first voltage increasing path while a fifth voltage lower than the second voltage is supplied to a fourth node;
the voltage at the plurality of first electrodes is further increased through a second voltage increasing path while a sixth voltage higher than the second voltage is supplied to a third node;
the voltage at the plurality of first electrodes is further increased through a third voltage increasing path while a seventh voltage lower than the first voltage is supplied to the third node; and
a third transistor is turned on while the fourth voltage is supplied to the first node, and the fourth voltage is supplied to the plurality of first electrodes.

13. The plasma display device of claim 12, wherein:
a third transistor is turned on while the fourth voltage is supplied to the first node, and the fourth voltage is supplied to the plurality of first electrodes;
a voltage of the plurality of first electrodes is decreased through a first voltage decreasing path while a fifth voltage higher than the first voltage is supplied to a third node;
the voltage at the plurality of first electrodes is further decreased through a second voltage decreasing path while a sixth voltage higher than the second voltage is supplied to a fourth node;
the voltage at the plurality of first electrodes is further decreased through a third voltage decreasing path while a seventh voltage lower than the first voltage is supplied to the fourth node; and
a fourth transistor is turned on while the third voltage is supplied to the second node, and the third voltage is supplied to the plurality of first electrodes.

14. The plasma display device of claim 13, wherein the first voltage is a positive voltage, and the second voltage is a negative voltage.

15. The plasma display device of claim 13, wherein the first and second voltages are both positive voltages.

16. A method of driving a plasma display device including a plurality of first electrodes and a plurality of second electrodes, the method comprising:
supplying a third voltage to the plurality of first electrodes through a first power source for supplying a first voltage and first and second capacitors charged to a second voltage;
increasing a voltage at the plurality of first electrodes through a first resonance path including the first power source and a first inductor;
further increasing the voltage at the plurality of first electrodes through a second resonance path including the first power source and a second inductor;
further increasing the voltage at the plurality of first electrodes through a third resonance path including the second inductor and a second power source supplying a fourth voltage higher than the first voltage;
supplying a sixth voltage to the plurality of first electrodes through the second power source and third and fourth capacitors charged to a fifth voltage;
decreasing the voltage at the plurality of first electrodes through a fourth resonance path including the second power source and the second inductor;
further decreasing the voltage at the plurality of first electrodes through a fifth resonance path including the first power source and the first inductor; and
further decreasing the voltage at the plurality of first electrodes through a sixth resonance path including the first power source and the first inductor.

17. The method of claim 16, wherein:
the first resonance path further comprises a first transistor coupled between the first power source and the first inductor;
the second resonance path further comprises a second transistor coupled between the first power source and the second inductor;
the third resonance path further comprises a third transistor coupled between the second power source and the second inductor;
the fourth resonance path further comprises a fourth transistor coupled between the second power source and the second inductor;
the fifth resonance path further comprises a fifth transistor coupled between the first power source and the first inductor; and
the sixth resonance path further comprises a sixth transistor coupled between the first power source and the first inductor.

18. The method of claim 17, wherein either increasing or decreasing the voltage of the plurality of first electrodes through the first, second, or sixth resonance path further comprises charging the third and fourth capacitors with the fifth voltage through a charging path including the second power source, the third and fourth capacitors, and the first power source.

19. The method of claim 18, wherein either increasing or decreasing the voltage of the plurality of first electrodes through the third to fifth resonance paths further comprises charging the first and second capacitors with the second voltage through a charging path including the second power source, the first and second capacitors, and the first power source.

20. The method of claim 17, wherein the first and second inductors have equal inductances.

21. The method of claim 17, wherein the second and third transistors are the same.

22. The method of claim 17, wherein the fifth and sixth transistors are the same.

23. A plasma display device comprising:
a plurality of first electrodes and a plurality of second electrodes;
a first transistor having a first terminal coupled to a first power source to supply a first voltage;
a second transistor having a first terminal coupled to a second terminal of the first transistor, and a second terminal coupled to a second power source to supply a second voltage lower than the first voltage;
a first capacitor charged to a third voltage, and having a first terminal coupled to the first power source;
a second capacitor charged to a fourth voltage, and having a first terminal coupled to a second terminal of the first capacitor and a second terminal coupled to a node between the first and second transistors;
a third capacitor charged to a fifth voltage, and having a first terminal coupled to a node between the first and second transistors;
a fourth capacitor charged to a sixth voltage, and having a first terminal coupled to a second terminal of the third capacitor and a second terminal coupled to the second power source;
a third transistor coupled between the first terminal of the first capacitor and the plurality of first electrodes;
a fourth transistor coupled between the second terminal of the fourth capacitor and the plurality of first electrodes;
a fifth transistor coupled between the first terminal of the second capacitor and the plurality of first electrodes, the fifth transistor increasing a voltage at the plurality of first electrodes upon being turned on;
a sixth transistor coupled between the first terminal of the second capacitor and the plurality of first electrodes, the sixth transistor decreasing the voltage at the plurality of first electrodes upon being turned on;
a seventh transistor coupled between the second terminal of the third capacitor and the plurality of first electrodes, the seventh transistor increasing the voltage at the plurality of first electrodes upon being turned on; and
an eighth transistor coupled between the second terminal of the third capacitor and the plurality of first electrodes, the eighth transistor decreasing the voltage at the plurality of first electrodes upon being turned on.

24. The plasma display device of claim 23, further comprising:
an inductor having a first terminal coupled to a node between a first terminal of the fifth transistor and a first terminal of the sixth transistor;
a first diode coupled between the first terminal of the fifth transistor and the first terminal of the inductor; and
a second diode coupled between a first terminal of the sixth transistor and the first terminal of the inductor.

25. The plasma display device of claim 23, wherein:
the first inductor and the first diode are coupled in series between the first terminal of the fifth transistor and the plurality of first electrodes; and
the second inductor and the second diode are coupled in series between the first terminal of the sixth transistor and the plurality of first electrodes.

26. The plasma display device of claim 23, further comprising:
an inductor having a first terminal coupled to a node between a first terminal of the seventh transistor and a first terminal of the eighth transistor;
a first diode coupled between the first terminal of the seventh transistor and the first terminal of the inductor; and
a second diode coupled between the first terminal of the eighth transistor and the first terminal of the inductor.

27. The plasma display device of claim 23, wherein:
the first inductor and the first diode are coupled in series between a first terminal of the seventh transistor and the plurality of first electrodes; and
the second inductor and the second diode are coupled in series between a first terminal of the eighth transistor and the plurality of first electrodes.

28. The plasma display device of claim 23, wherein:
a voltage corresponding to a difference between the second voltage and a voltage of the third and fourth capacitors is supplied to the first electrode upon the second and fourth transistors being turned on;
the voltage at the plurality of first electrodes is increased upon the fourth transistor being turned off and the seventh transistor being turned on;
the voltage at the plurality of first electrodes is further increased upon the seventh transistor being turned off and the fifth transistor being turned on;
the voltage at the plurality of first electrodes is further increased upon the first transistor being turned on; and
a voltage corresponding to a sum of the first voltage and a voltage of the first and second capacitors is supplied to the plurality of first electrodes upon the fifth transistor being turned off and the third transistor being turned on.

29. The plasma display device of claim 28, wherein:
a voltage corresponding to a sum of the first voltage and a voltage of the first and second capacitors is supplied to the plurality of first electrodes upon the first and third transistors being turned on;
the voltage at the plurality of first electrodes is decreased upon the third transistor being turned off and the sixth transistor being turned on;
the voltage at the plurality of first electrodes is further decreased upon the first and sixth transistors being turned off and the eighth transistor being turned on;
the voltage at the plurality of first electrodes is further decreased upon the second transistor being turned on; and
a voltage corresponding to a difference between the second voltage and a voltage of the third and fourth capacitors is supplied to the plurality of first electrodes upon the fourth transistor being turned on.

30. The plasma display device of claim 23, wherein the first and fourth voltages are equal, and the fifth and sixth voltages are equal.
